(19) United States
(12) Patent Application Publication
(10) Pub. No.: US 2025/0275577 A1
(43) Pub. Date: Sep. 4, 2025

(54) AEROSOL GENERATING DEVICE AND HEATING ASSEMBLY

(71) Applicant: SMOORE INTERNATIONAL HOLDINGS LIMITED, George Town (KY)

(72) Inventors: Lei MA, Shenzhen (CN); Hongming ZHOU, Shenzhen (CN); Rihong LI, Shenzhen (CN); Xianwu DU, Shenzhen (CN); Guo ZHANG, Shenzhen (CN)

(21) Appl. No.: 19/211,101

(22) Filed: May 16, 2025

Related U.S. Application Data
(63) Continuation of application No. PCT/CN2023/114120, filed on Aug. 21, 2023.

(30) Foreign Application Priority Data
Nov. 17, 2022 (CN) 202211458267.6

(51) Int. Cl. A24F 40/46; H05B 3/00

(52) U.S. Cl. CPC A24F 40/46; H05B 3/0071

(57) ABSTRACT

The present disclosure relates to an aerosol generating device and a heating assembly. The heating assembly includes a heating portion configured to generate infrared light waves in a power-on state and a sleeve for the infrared light waves to pass through. The heating portion includes a heating substrate, an antioxidant layer arranged on the outer surface of the heating substrate and configured to prevent the heating substrate from being oxidized, and an infrared radiation layer arranged on the side of the antioxidant layer away from the heating substrate. An accommodating cavity configured to accommodate the heating portion and non-sealed is formed in the sleeve. In the heating assembly, with the antioxidant layer, the sleeve's accommodating cavity doesn't require sealing, vacuuming, or inert gas filling. This simplifies the assembly process and cuts manufacturing costs.

### CROSS-REFERENCE TO PRIOR APPLICATION

This application is a continuation of International Patent Application No. PCT/CN2023/114120, filed on Aug. 21, 2023, which claims priority to Chinese Patent Application No. 202211458267.6, filed on Nov. 17, 2022. The entire disclosure of both applications is hereby incorporated by reference herein.

### FIELD

The present disclosure relates to the field of heat-not-burn atomization, and in particular, to an aerosol generating device and a heating assembly.

### BACKGROUND

In the field of HNB (heat-not-burn) atomization, heating methods such as heating through a central heating element heating or a circumferential heating element are generally adopted. The usual approach is that the heating element generates heat, and then the heat is directly transferred to an aerosol generating substrate through thermal conduction. The substrate is usually atomized within 350° C. The disadvantage of this heating method is that since the heating element conducts heat directly or indirectly through a solid material to the aerosol generating substrate, it requires that the working temperature of the heating element should not be too high, and otherwise it will cause the aerosol generating substrate to be overheated or the solid material to produce a peculiar smell to influence the puffing taste of the electronic cigarette.

In the related arts, since the heating assembly that generates thermal radiation for heating is adopted and the working temperature of the heating element may reach around 400° C., when the heating element works at high temperatures, its substrate material will have the problem of oxidation, resulting in significant changes in the resistance value of the heating element and affecting its heating stability. To solve the problem of oxidation, the sealed mounting space is generally vacuumed or filled with inert gas. The process is not only complex but also has a high manufacturing cost.

### SUMMARY

In an embodiment, the present invention provides a heating assembly, comprising: a heating portion configured to generate infrared light waves in a power-on state; and a sleeve for the infrared light waves to pass through, wherein the heating portion comprises a heating substrate, wherein an antioxidant layer is arranged on an outer surface of the heating substrate and configured to prevent the heating substrate from being oxidized, wherein an infrared radiation layer is arranged on a side of the antioxidant layer away from the heating substrate, wherein an accommodating cavity configured to accommodate the heating portion and is formed in the sleeve, the accommodating cavity being non-sealed, and wherein the heating portion is at least partially spaced apart from a tube wall of the sleeve.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic exploded structural diagram of an aerosol generating device according to a first embodiment of the present disclosure.

FIG. 2 is a schematic structural diagram of a heating assembly of the aerosol generating device in FIG. 1.

FIG. 3 is a first longitudinal cross-sectional diagram of the heating assembly in FIG. 2.

FIG. 4 is a second longitudinal cross-sectional diagram of the heating assembly in FIG. 2.

FIG. 5 is a third longitudinal cross-sectional diagram of the heating assembly in FIG. 2.

FIG. 6 is a schematic exploded structural diagram of the heating assembly in FIG. 2.

FIG. 7 is a schematic bottom structural diagram of the heating assembly in FIG. 2.

FIG. 8 is a transverse cross-sectional diagram of a heating element of the heating assembly in FIG. 6.

FIG. 9 is a transverse cross-sectional diagram of a heating element of an aerosol generating device according to a second embodiment of the present disclosure.

FIG. 10 is a transverse cross-sectional diagram of a heating element of an aerosol generating device according to a third embodiment of the present disclosure.

### DETAILED DESCRIPTION

In an embodiment, the present invention provides an improved heating assembly and further provide an improved aerosol generating device.

In an embodiment, the present invention provides a heating assembly, including a heating portion configured to generate infrared light waves in a power-on state and a sleeve for the infrared light waves to pass through.

The heating portion includes a heating substrate, an antioxidant layer arranged on the outer surface of the heating substrate and configured to prevent the heating substrate from being oxidized, and an infrared radiation layer arranged on the side of the antioxidant layer away from the heating substrate; and
an accommodating cavity configured to accommodate the heating portion and non-sealed is formed in the sleeve, and the heating portion is at least partially spaced apart from the tube wall of the sleeve.

In some embodiments, the antioxidant layer includes an oxide film, and the oxide film is formed on the outer surface of the heating substrate.

In some embodiments, the thickness of the antioxidant layer is 1 um-150 um.

In some embodiments, an air gap is provided between the inner wall of the accommodating cavity and the heating portion.

In some embodiments, the sleeve includes a hollow tubular body;
the accommodating cavity is formed in the tubular body; and
one end of the tubular body is provided with an opening.

In some embodiments, the heating portion is connected to two conductive portions; and
the two conductive portions penetrate through the opening.

In some embodiments, the sleeve includes a pointed structure, and the pointed structure is arranged at the end of the tubular body away from the opening.

In some embodiments, the number of the conductive portions is two, and the two conductive portions are spaced apart; and
the heating assembly further includes an insulating member at least partially arranged in the sleeve and configured to insulate the two conductive portions.

In some embodiments, the heating assembly further includes a supporting base configured to support the heating portion and the sleeve; and the sleeve is at least partially inserted into the supporting base.

In some embodiments, a conductive member connected to the conductive portions is provided in the supporting base.

In some embodiments, the supporting base includes a holder configured to support the sleeve, and a seal member; and
the seal member is sleeved over a partial section of the sleeve and seals a gap between the inner wall of the holder and the outer wall of the sleeve.

In some embodiments, the seal member is a hollow structure with two ends running through, and a channel for the sleeve to pass through is formed on the inner side.

In some embodiments, the seal member includes a sleeve body with two ends running through and configured to be partially sleeved over the sleeve, and a first seal portion protruding from the outer side wall of the sleeve body; and
the first seal portion is clamped and fixed with the holder.

In some embodiments, the supporting base includes a shell sleeved over the outer periphery of the holder and provided with a sleeve opening for cooperating with the holder; and
the holder includes the bottom wall, and a gap is provided between the sleeve opening and the bottom wall.

In some embodiments, the shell is detachably sleeved over the holder; and
the shell is provided with a through hole for the heating structure to partially penetrate through.

In some embodiments, the seal member further includes a sleeve body with two ends running through and configured to be partially sleeved over the sleeve, and a second seal portion protruding from the outer side wall of the sleeve body; and the second seal portion is located between the holder and the shell in an assembled state of the shell and the holder, and is configured to seal a gap formed between the holder and the end surface of the through hole.

In some embodiments, the sleeve is made of infrared transparent glass, transparent ceramics, or diamond.

In some embodiments, the heating element is spaced apart from the tube wall of the sleeve on the whole.

In some embodiments, the heating element is arranged without being in direct contact with the sleeve.

In some embodiments, the infrared radiation layer includes an infrared layer and/or a composite infrared layer, and the composite infrared layer is formed by compounding an infrared layer forming substrate with a bond configured to bond with the antioxidant layer.

In some embodiments, the heating substrate includes a metal substrate; and the metal substrate includes a nickel-chromium alloy substrate
or an iron-chromium-aluminum alloy substrate.

The present disclosure further provides an aerosol generating device, including the heating assembly described above.

The aerosol generating device and the heating assembly in the present disclosure have the following beneficial effects: In the heating assembly, by arranging the antioxidant layer on the outer surface of the heating substrate of the heating portion, the heating substrate can be prevented from being oxidized, so that the accommodating cavity for accommodating the heating portion in the sleeve can be non-sealed, that is, the sleeve does not need to be sealed, vacuumed, or filled with inert gas, and the space in the sleeve can be communicated with the atmosphere outside the instrument, thereby simplifying the assembling process of the heating assembly and reducing the manufacturing cost.

In addition, by arranging the infrared radiation layer on the outer surface of the heating substrate, when the heating substrate generates heat in a power-on state, the heat can excite the infrared radiation layer to radiate infrared light waves, and the infrared light waves can pass through the sleeve to reach and heat the aerosol generating substrate. In a case that the highest working temperature of the heating element reaches 1000° C. or above (the working temperature of traditional HNB heating elements generally does not exceed 400° C.), it will not cause the aerosol generating substrate to be overheated, thereby greatly improving the puffing taste. Moreover, in a high-temperature working state, the preheating time is greatly reduced, thereby greatly improving the consumer experience.

To provide a clearer understanding of the technical features, objectives, and effects of the present disclosure, the specific embodiments of the present disclosure will be described below with reference to the drawings.

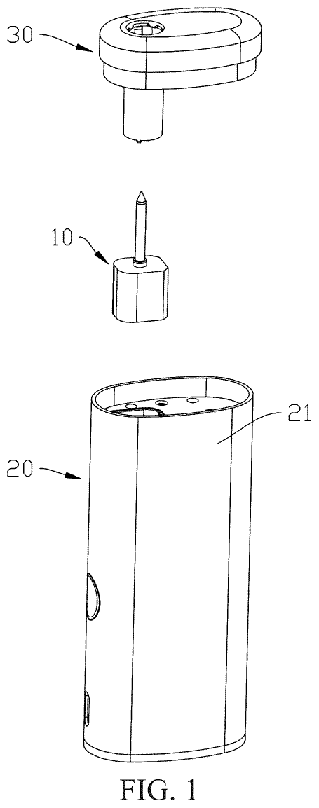

FIG. 1 illustrates an aerosol generating device according to a first embodiment of the present disclosure. The aerosol generating device 100 may adopt a low-temperature heat-not-burn method to heat an aerosol generating substrate, and has the advantages of good atomization stability and excellent puffing taste. In some embodiments, the aerosol generating substrate may be arranged in the aerosol generating device 100 in a pluggable manner. The aerosol generating substrate may be cylindrical. Specifically, the aerosol generating substrate may be a filamentous or sheet-like solid material made from leaves and/or stems of plants, and aroma components may be further added to the solid material.

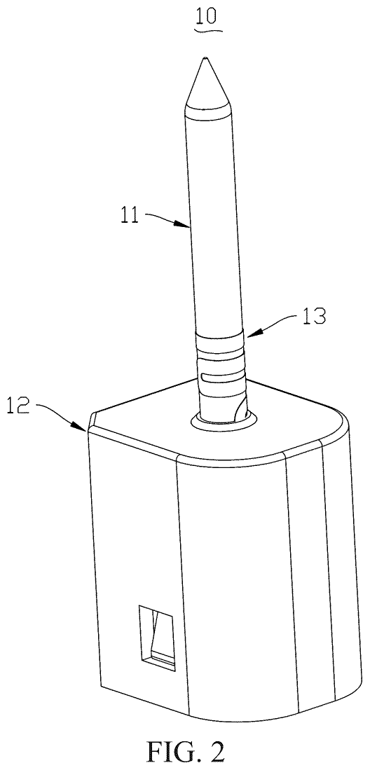

Referring to FIG. 1 and FIG. 2, further, in this embodiment, the aerosol generating device 100 includes a heating assembly 10 and a power supply assembly 20. The power supply assembly 20 includes a power supply case 21. The heating assembly is accommodated in the power supply case 21 and may be partially inserted into the aerosol generating substrate. Specifically, it may be partially inserted into a substrate section of the aerosol generating substrate, and generates infrared radiation to heat the substrate section of the aerosol generating substrate in a power-on state, causing it to be atomized to generate an aerosol. The heating assembly 10 has the advantages of easiness in assembling, simple structure, high atomization efficiency, strong stability, and long service life. The power supply assembly 20 is mechanically and/or electrically connected to the heating assembly 10 and is configured to supply power to the heating assembly 10.

In this embodiment, the heating assembly 10 includes a heating structure 11 and a supporting base 12. The heating structure 11 is mounted on the supporting base 12. In this embodiment, the heating structure 11 and the supporting base 12 are detachably mounted to facilitate the replacement and maintenance of the heating structure 11. The supporting base 12 may be mechanically and electrically connected to the heating structure 11. It can not only support the heating structure 11, but also be electrically connected to the heating structure 11 when the heating structure 11 is mounted on it, thereby electrically connecting the heating structure 11 to the power supply assembly 20. As can be understood, in some other embodiments, the supporting base 12 may only play a supporting role.

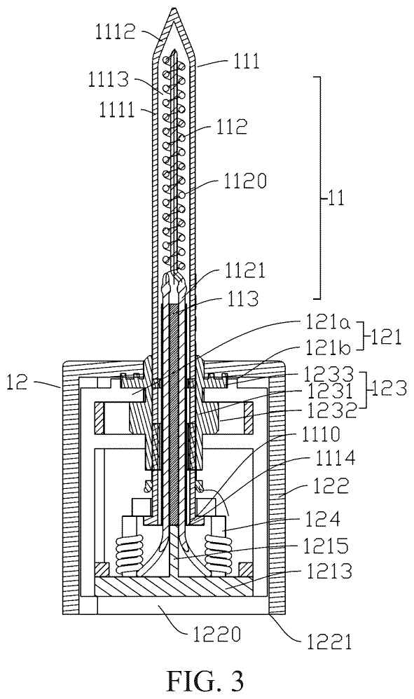

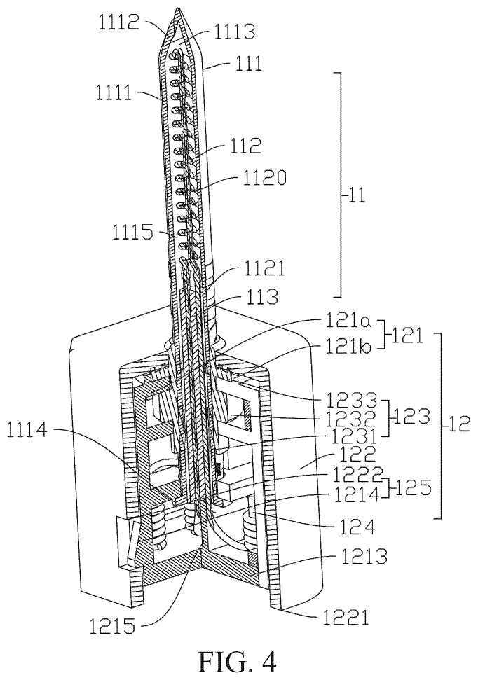

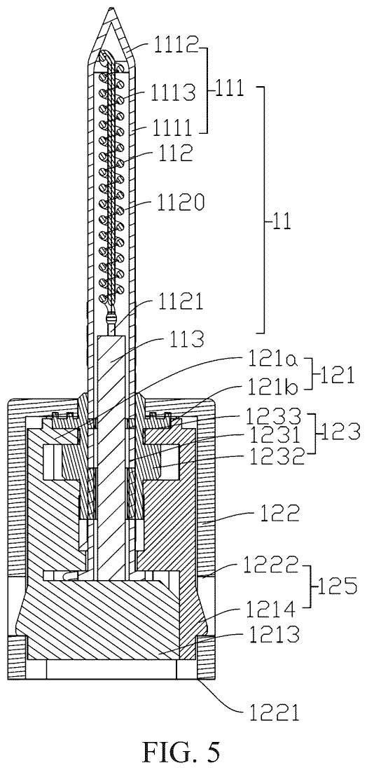

Referring to FIG. 3 to FIG. 5, in this embodiment, the heating structure 11 includes a sleeve 111 and a heating element 112. The sleeve 111 is at least partially inserted into the supporting base 12, covers at least part of the heating element 112, and may allow light waves to pass through to reach the aerosol generating substrate. Specifically, in this embodiment, the sleeve 111 may allow infrared light waves to pass through, thereby facilitating the heating element 112 to radiate heat to heat the aerosol generating substrate. Specifically, in this embodiment, the heating element 112 is spaced apart from the tube wall of the sleeve 111 on the whole, and a gap is provided between the inner wall of the sleeve 111 and the heating element 112. In a power-on state, the heating element quickly heats to increase the temperature up to 1000-1300° C. within 1-3 s, the surface temperature of the sleeve 111 can be controlled below 350° C., and the overall atomization temperature of the aerosol generating substrate is controlled at 300-350° C., thereby achieving the precise atomization of the aerosol generating substrate mainly in a wave band of 2-5 um. In the present disclosure, the highest working temperature of the heating element ranges from 500° C. to 1300° C., which is much higher than the highest working temperature of the heating element in the existing technology.

In this embodiment, the sleeve 111 may be a quartz glass tube. Of course, as can be understood, in some other embodiments, the sleeve 111 is not limited to a quartz tube and may be any other window material that allows light waves to pass through, such as infrared transparent glass, transparent ceramics, or diamond.

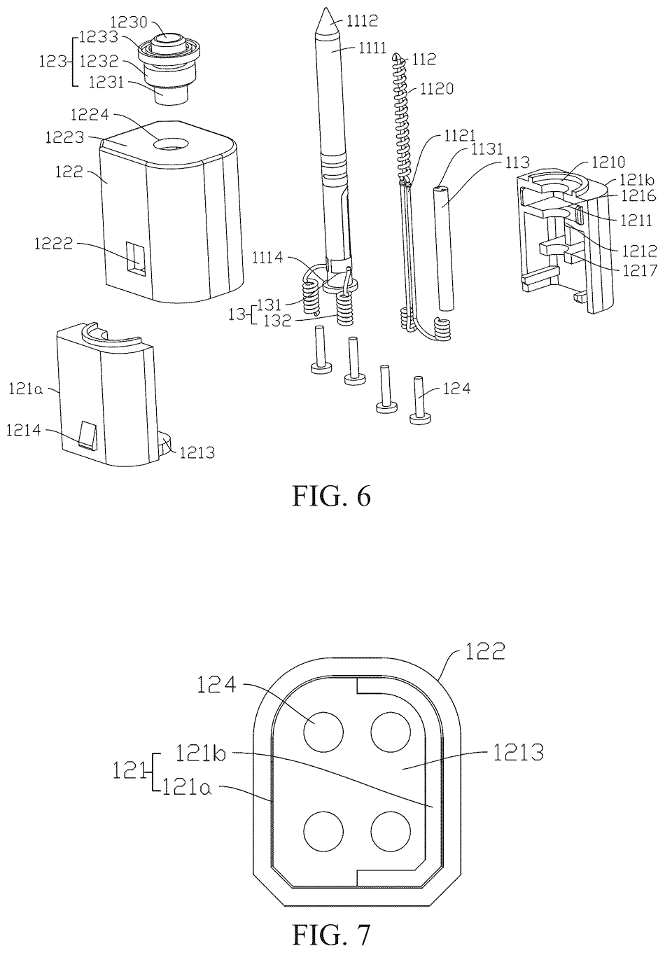

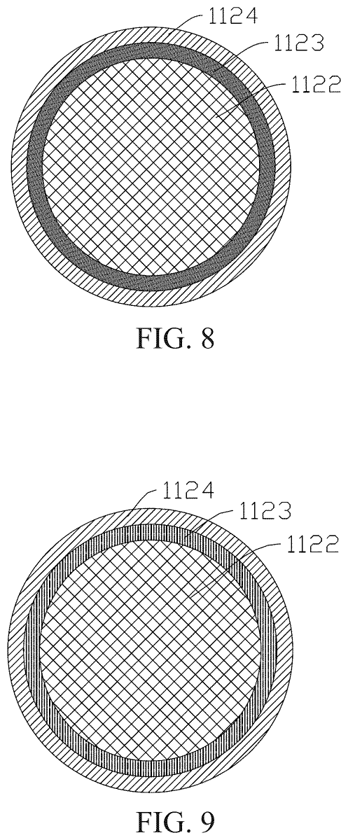

Referring to FIG. 6 to FIG. 8, in this embodiment, the sleeve 111 is a hollow tubular body. Specifically, the sleeve 111 includes a tubular body 1111 with a circular cross section, and a pointed structure 1112 arranged at one end of the tubular body 1111. Of course, as can be understood, in some other embodiments, the cross section of the tubular body 111 is not limited to be circular. The tubular body 1111 is a hollow structure with an opening 1110 in one end. The pointed structure 1112 is arranged at the end of the tubular body 1111 away from the opening 1110. By arranging the pointed structure 1112, it is convenient for at least part of the heating structure 111 to be plugged into the aerosol generating substrate. In this embodiment, an accommodating cavity 1113 is formed on the inner side of the sleeve 111. The accommodating cavity 1113 is a cylindrical cavity and may be non-sealed. The air in the accommodating cavity 1113 may be communicated with the atmosphere outside the instrument. When the heating element 112 is mounted in it, the accommodating cavity 1113 does not need to be vacuumed or filled with inert gas. In this embodiment, the sleeve 111 further includes a positioning portion 1114. The positioning portion 1114 is arranged at the opening 1110 of the tubular body 111 and may extend radially outwards along the tubular body 111 to form a positioning flange for the mounting and positioning of the sleeve 111 and the supporting base 12. In this embodiment, the positioning portion 1114 may be integrally formed with the tubular body 111. Of course, as can be understood, in some other embodiments, the positioning portion 1114 may be detachably assembled with the sleeve 111 by sleeving, screwing, or clamping, for example. In this embodiment, an air gap is provided between the inner wall of the sleeve 111 and the heating element 112. The air gap may be filled with air. By providing the air gap, there can be no direct contact between the sleeve 111 and the heating element 112.

In this embodiment, the number of the heating element 112 may be one, which may be longitudinally arranged and wound to form a heating portion 1120 which is spiral on the whole. Specifically, the heating element 112 may be cylindrical on the whole and may be wound to form a single-spiral structure, double-spiral structure, M-shaped structure, N-shaped structure, or structure with any other shape. Of course, as can be understood, in some other embodiments, the number of the heating element 112 is not limited to one, and may be two or more. The shape of the heating element 112 is not limited to a cylindrical shape. In some embodiments, the shape of the heating element 112 may be a sheet shape.

In this embodiment, the heating portion 1120 may be placed in the sleeve 111, spaced apart from the inner wall of the sleeve 111, and configured to generate infrared radiation, that is, generate infrared light waves, in a power-on state. The infrared light waves may pass through the sleeve 111 to reach the aerosol generating substrate. In this embodiment, the heating portion 1120 may be in a longitudinally elongated spiral shape. Of course, as can be understood, in some other embodiments, the heating portion 1120 is not limited to a spiral shape.

In this embodiment, one end of the heating portion 1120 is provided with a conductive portion 1121. The conductive portion 1121 is connected to the heating portion 1120, and may be led out from the opening 1110 of the sleeve 111, penetrate through a base, and be electrically connected to the power supply assembly 20. In this embodiment, the conductive portion 1121 may be fixed to the heating portion 1120 through welding to form an integrated structure. Of course, as can be understood, in some other embodiments, the heating portion 1120 may be integrally formed with the conductive portion 1121. In this embodiment, the number of the conductive portions 1121 may be two. The two conductive portions 1121 may be spaced apart, be respectively connected to two ends of the heating portion 1120, extend towards the same end, and penetrate through the sleeve 111 from the opening 1110 in one end of the sleeve 111. In this embodiment, the conductive portion 1121 may be a lead wire, which may be welded to the heating portion 1120. Of course, as can be understood, in some other embodiments, the conductive portion 1121 is not limited to a lead wire and may be any other conductive structure. By arranging the conductive portion 1121 at one end of the heating portion 1120 and leading it out from the sleeve 111, the entire heating structure 11 can be conveniently assembled, thereby simplifying the assembling process. During assembling, the heating structure 11 may be mounted on the supporting base 12, and then enabled to be in contact with a conductive member 124 located in the supporting base 12.

In this embodiment, the heating element 112 forming the heating portion 1120 includes a heating substrate 1122 and an infrared radiation layer 1124. The heating substrate 1122 may generate heat in a power-on state. The infrared radiation layer 1124 is arranged on the outer surface of the heating substrate 1122, and is heated through the heating substrate 1122 to excite and radiate infrared light waves. In this embodiment, the heating substrate 1122 and the infrared radiation layer 1124 are concentrically distributed on the cross section of the heating portion 1120.

In this embodiment, the heating substrate 1122 may be cylindrical on the whole. Specifically, the heating substrate 1122 may be a heating wire. Of course, as can be understood, in some other embodiments, the heating substrate 1122 may not be limited to be cylindrical, but may be in a sheet shape, that is, the heating substrate 1122 may be a heating sheet. The heating substrate 1122 includes a metal substrate with high-temperature oxidation resistance. The metal substrate may be a metal wire. Specifically, the heating substrate 1122 may be a nickel-chromium alloy substrate (such as nickel-chromium alloy wire), iron-chromium-aluminum alloy substrate (such as iron-chromium-aluminum alloy wire) or the like made of a metal material with good high-temperature oxidation resistance, high stability, and good deformation resistance. In this embodiment, the radial size of the heating substrate 1122 may be 0.15 mm-0.8 mm.

In this embodiment, the heating element 112 further includes an antioxidant layer 1123, and the antioxidant layer 1123 is formed between the heating substrate 1122 and the infrared radiation layer 1124. Specifically, the antioxidant layer 1123 may be an oxide film, the heating substrate 1122 undergoes high-temperature heat treatment to form a dense oxide film on its own surface, and the oxide film forms the antioxidant layer 1123. Of course, as can be understood, in some other embodiments, the antioxidant layer 1123 is not limited to include an oxide film formed by itself. In some other embodiments, it may be an antioxidant coating layer coated on the outer surface of the heating substrate 1122. By forming the antioxidant layer 1123, it can ensure that the heating substrate 1122 is not or is rarely oxidized when heated in the air environment, thereby improving the stability of the heating substrate 1122. Therefore, there is no need to vacuum, fill inert gas or reducing gas into the accommodating cavity 1113, nor to block the opening 1110, thereby simplifying the assembling process of the entire heating structure 11 and reducing the manufacturing cost. In this embodiment, the thickness of the antioxidant layer 1123 may be selectively 1 um-150 um. When the thickness of the antioxidant layer 1123 is less than 1 um, the heating substrate 1122 is easily oxidized. When the thickness of the antioxidant layer 1123 is greater than 150 um, it will influence the heat conduction between the heating substrate 1122 and the infrared radiation layer 1124.

In this embodiment, the infrared radiation layer 1124 may be an infrared layer. The infrared layer may be an infrared layer forming substrate formed on the side of the antioxidant layer 1123 away from the heating substrate 1122 under high-temperature heat treatment. In this embodiment, the infrared layer forming substrate may be a silicon carbide, spinel, or composite substrate thereof. Of course, as can be understood, in some other embodiments, the infrared radiation layer 1124 is not limited to an infrared layer. In some other embodiments, the infrared radiation layer 1124 may be a composite infrared layer. In this embodiment, the infrared layer may be formed on the side of the antioxidant layer 1123 away from the heating substrate 1122 through dip coating, spray coating, brush coating, and other methods. The thickness of the infrared radiation layer 1124 may be 10 um-300 um. When the thickness of the infrared radiation layer 1124 is between 10 um-300 um, the thermal radiation effect is better, and the atomization efficiency and taste of the aerosol generating substrate are better. Of course, as can be understood, in some other embodiments, the thickness of the infrared radiation layer 1124 is not limited to 10 um-300 um.

In this embodiment, the heating assembly 11 further includes an insulating member 113, the insulating member 113 is cylindrical, and its radial size may be smaller than the radial size of the accommodating cavity 1113. The insulating member 113 may fully or partially penetrate into the accommodating cavity 1113 through the opening 1110 of the sleeve 111, thereby separating the two conductive portions 1121, that is, insulating the two conductive portions 1121. In this embodiment, the insulating member 113 is provided with through holes 1131, the number of the through holes 1131 is two, the two through holes 1131 correspond to the two conductive portions 1121 one to one, and the through holes 1131 may extend along the axial direction of the insulating member 113 and be configured to allow the conductive portions 1121 to penetrate through for electrical connection with the supporting base 12. In some embodiments, the insulating member 113 may not be limited to be cylindrical. In some embodiments, the insulating member 113 may be an insulating partition, and the through holes 1131 may be omitted. In some embodiments, the insulating member 113 may be a ceramic body, quartz tube, or any other insulating structure.

Further referring to FIG. 3 to FIG. 7, in this embodiment, the supporting base 12 may support the sleeve 111 and the heating portion 1120, and include a holder 121, a shell 122, and a seal member 123. The holder 121 is configured to support the heating structure 11. The shell 122 may be sleeved over the outer periphery of the holder 121. The seal member 123 may be mounted on the holder 121 and configured to hermetically connect the heating structure 11 with the holder 121 and the shell 122.

In this embodiment, the holder 121 includes a first holder body 121a and a second holder body 121b that are openable and closable. By arranging the first holder body 121a and the second holder body 121b that are openable and closable, the mounting and dismounting of the heating structure 11 can be facilitated. In some embodiments, splicing the first holder body 121a and the second holder body 121b can form a rectangular solid structure. Of course, as can be understood, in some other embodiments, it is not limited to form a rectangular solid shape by splicing the first holder body 121a and the second holder body 121b. In some other embodiments, splicing the first holder body 121a and the second holder body 121b may form a cylindrical or other shape.

In this embodiment, one end of each of the first holder body 121a and the second holder body 121b is provided with an end plate 1210, separating plates 1212 are correspondingly arranged in both the first holder body 121a and the second holder body 121b, the separating plates 1212 divide the holder 121 into upper and lower spaces, a clamping groove 1211 for cooperating with the seal member 123 is formed in the space close to the end plate 1210, each separating plate 1212 is provided with a semi-cylindrical first avoidance hole 1216, and the two separating plates 1212 of the first holder body 121a and the second holder body 121b are arranged opposite to each other, and the first avoidance holes 1216 are spliced to form a first through hole for the heating structure 11 to pass through.

In this embodiment, the holder 121 further includes the bottom wall 1213, and the bottom wall 1213 is arranged on the first holder body 121a. Of course, as can be understood, in some other embodiments, the bottom wall 1213 is not limited to be arranged on the first holder body 121a, but may also be arranged on the second holder body 121b.

In this embodiment, a separating member 1215 is arranged in the supporting base 12. Specifically, the separating member 1215 protrudes from the bottom wall 1213 and is integrally formed with the bottom wall 1213. It may be a rib plate and be configured to separate the two adjacent conductive portions 1121 and insulate the two conductive portions 1121.

In this embodiment, the first holder body 121a and the second holder body 121b are provided with limiting plate 1216 for limiting the heating structure 11, the limiting plates 1216 are arranged below the separating plates 1212 and are spaced apart from the separating plates 1212, and each limiting plate 1216 is provided with a semi-cylindrical second avoidance hole 1217. When the first holder body 121a and the second holder body 121b are spliced, the two second avoidance holes 1217 in the two limiting plates 1216 are spliced to form a second through hole for the heating structure 11 to pass through. The radial size of the second through hole is smaller than the radial size of the positioning portion 1114 at one end of the sleeve 111, thereby cooperating with the positioning portion 1114 to position the heating structure 11.

In this embodiment, the shell 122 may be sleeved over the outer periphery of the holder 121 after the heating structure 11 is assembled with the holder 121, thereby playing a role of fixing the first holder body 121a and the second holder body 121b, so that the heating structure 11 and the supporting base 12 form an integrated structure. In this embodiment, the shape and size of the shell 122 may be adapted to the holder 121. In this embodiment, the shell 122 is roughly in a rectangular solid shape and is a hollow structure with a sleeve opening 1221 in one end. A gap 1220 is provided between the sleeve opening 1221 and the bottom wall 1213, thereby preventing the residual aerosol in the power supply case 21 from condensing and forming condensate that affects the normal operation of the heating structure 11.

In this embodiment, the shell 122 may be detachably connected with the holder 121. Specifically, in this embodiment,
the shell 122 and the holder 121 are provided with a connecting structure 125, and the shell 122 and the holder 121 are detachably connected through the connecting structure 125. In this embodiment, the connecting structure 125 includes clamping holes 1222 and clamping buckles 1214. The clamping buckles 1214 protrude from the outer side wall of the holder 121. Specifically, the number of the clamping buckles 1214 is two. The two clamping buckles 1214 are correspondingly arranged on the outer side walls of the first holder body 121a and the second holder body 121b. The clamping holes 1222 are provided in the side wall of the shell 122 and the number is two. The two clamping holes 1222 correspond to the two clamping buckles 1214 one to one. When the shell 122 is assembled with the holder 121, the clamping buckles 1214 can be clamped into the clamping holes 1222, thereby connecting and fixing the shell 122 and the holder 121.

In this embodiment, the side of the shell 122 opposite to the sleeve opening 1221 is provided with a blocking wall 1223, and the shell 122 is provided with a through hole 1224. Specifically, the through hole 1224 is provided in the blocking wall 1223 and can allow the heating structure 11 to partially penetrate through.

In this embodiment, the seal member 123 is detachably arranged between the first holder body 123a and the second holder body 123b, and the seal member 123 is detachably sleeved over the heating structure 11. Specifically, it may be sleeved over the outer periphery of a partial section of the sleeve 111, and configured to hermetically connect the heating structure 11 with the first holder body 121a and the second holder body 121b. In this embodiment, the seal member 123 may be a silica gel member, which serves to prevent vibration and prevent damage when the sleeve 111 and the holder 121 are assembled. Of course, as can be understood, in some other embodiments, the seal member 123 is not limited to a silica gel member.

In this embodiment, the seal member 123 is a hollow structure with two ends running through, a channel 1230 may be formed on the inner side, and the channel 1230 may allow the sleeve 11 to pass through. In this embodiment, the seal member 123 includes a sleeve body 1231, a first seal portion 1232, and a second seal portion 1233. The sleeve body 1231 is cylindrical, is a hollow structure with two ends running through, and is configured to be sleeved over part of the heating structure 11. The first seal portion 1232 and the second seal portion 1233 protrude from the outer side wall of the sleeve body 1231, and are spaced apart along the axial direction of the sleeve body 1231. The first seal portion 1232 may be arranged along the circumferential direction of the sleeve body 1232, and may be roughly in a circular ring shape. The first seal portion 1232 is respectively clamped and fixed with the first holder body 121a and the second holder body 121b. Specifically, the first seal portion 1232 may be respectively clamped into the clamping grooves 1211 in the first holder body 121a and the second holder body 121b. The second seal portion 1233 protrudes from the outer side wall of the sleeve body 1231 and is roughly in a circular ring shape, and its radial size is larger than the radial size of the first seal portion 1232. The second seal portion 1233 may be placed on the side where the end wall 1210 of the first holder body 121a and the second holder body 121b is opposite to the clamping groove 1211. In an assembled state of the shell 12 and the holder 121, the second seal portion 1233 is located between the shell 122 and the holder 121. Specifically, it is located between the blocking wall 1223 and the end wall 1210, and is configured to seal a gap formed between the holder 121 and the end surface of the through hole 1224. In this embodiment, the sleeve body 1231, the first seal portion 1232, and the second seal portion 1233 are an integrally formed structure, forming multiple sealing structures. That is, by arranging the seal member 123, the sealing among the shell 122, the heating structure 11, and the holder 121 can be achieved, thereby simplifying the sealing process, reducing the manufacturing cost, and preventing condensate from flowing into the holder 121.

In this embodiment, multiple conductive members 124 are arranged on the supporting base 12. Specifically, the conductive members 124 are arranged corresponding to the conductive portions 1121 one to one. Of course, as can be understood, in some other embodiments, the number of the conductive member 124 may be one. The conductive member 124 may be an electrode pillar. The multiple conductive members 124 are spaced apart on the bottom wall 1213, and may be detachably connected to the conductive portions 1121. Specifically, in a state that the heating structure 11 is mounted on the supporting base 12, the conductive portion 1121 may be wound around the conductive member 124, thereby being electrically connected to the conductive member 124. In this embodiment, the conductive member 124 may be electrically connected with a power supply in the power supply assembly 20 through contact, thereby electrically connecting the heating structure 11 with the power supply assembly 20 and facilitating the replacement of the heating element 122 when the heating element 112 reaches its service life. In this embodiment, the number of the conductive members 124 is two groups, one group is electrically connected to the heating structure 11, and the other group may be connected to a temperature measurement structure 13. Of course, as can be understood, in some other embodiments, the number of the conductive member 124 may be one group, and the heating structure 11 and the temperature measurement structure 13 may share one group of conductive members 124.

In this embodiment, the heating assembly 10 further includes a temperature measurement structure 13. The temperature measurement structure 13 is arranged on the heating structure 11 and may be detachably connected to the supporting base 12. In this embodiment, the temperature measurement structure 13 may be sleeved over the outer periphery of a partial section of the sleeve 111, and may be detachably connected to the conductive member 124 in the supporting base 12 and electrically connected to it when connected thereto. In this embodiment, the temperature measurement structure 13 is sleeved over a position on the sleeve 111 corresponding to a position of connection between the heating portion1120 and the conductive portions 1121, and includes a temperature measurement film 131 and lead wires 132. The temperature measurement film 131 may be sleeved over the outer side wall of the sleeve 111. The number of the lead wire 132 is two. The two lead wires 132 are spaced apart, one end of each lead wire is connected to the temperature measurement film 131, the other end of each lead wire may be connected to the conductive member 132 in the supporting base 12, and they may be wound around the corresponding conductive members 132 for electrical connection and signal transmission. In some embodiments, the lead wires 132 may be connected to the temperature measurement film 131 by welding or crimping.

When the heating assembly 10 is assembled, the temperature measurement structure 13 may be first sleeved over the outer periphery of the sleeve 111, and then the seal member 123 is sleeved over the sleeve 111 of the heating structure 11. The first holder body 121a is clamped at the first seal portion 1232 of the seal member 123. Then, the conductive portions 1121 of the heating structure 11 and the lead wires 132 of the temperature measurement structure 13 are wound around the corresponding conductive members 124. Then, the second holder body 121b is clamped at the second seal portion 1232. Finally, the overall structure formed by the holder 121 and the heating structure 11 is inserted into the sleeve opening 1221 in the shell 122, so that the second seal portion 1233 is pressed against the blocking wall 1223 of the shell 122 and the end wall 1210 of the holder 121, the seal member 123 and the heating structure 11 are enabled to partially penetrate through the through hole 1224, and the clamping buckles 1214 on the outer side of the holder 121 are clamped into the sleeve opening 1221 in the shell 122. If the heating structure 11 needs to be disassembled, the shell 122 is pushed out towards the direction of the pointed structure 1112 of the heating structure 11, then the first holder body 121a and the second holder body 121b are separated from the seal member 123, and finally the conductive portions 1121 and the lead wires 132 of the temperature measurement structure 13 are disconnected from the conductive members 124.

FIG. 9 shows an aerosol generating device according to a second embodiment of the present disclosure, the difference between the second embodiment and the first embodiment lies in that the infrared radiation layer 1124 is a composite infrared layer. The composite infrared layer may be formed by compounding an infrared layer forming substrate with a bond configured to bond with the antioxidant layer 1123. Specifically, the bond may be glass powder. The composite infrared layer may be a glass powder composite infrared layer. The reason for adopting glass powder is that glass powder can melt at high temperatures to bond the antioxidant layer 1123 with the infrared layer forming substrate and block the gap in the infrared layer forming substrate, thereby further improving the breakdown resistance. The glass powder composite infrared layer may be prepared by adding glass powder to the infrared layer forming substrate (such as silicon carbide or spinel), performing compounding, then coating the mixture onto the side of the antioxidant layer 1123 away from the heating substrate 1122 through dip coating, spray coating or brush coating, performing heat treatment for 30 min in a tunnel furnace, then placing the obtain material in a heating furnace, increasing the temperature to 1000-1200° C., preserving the heat for 2 h, and then cooling to room temperature with the furnace.

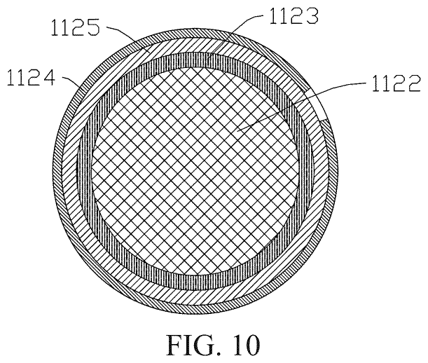

FIG. 10 shows an aerosol generating device according to a third embodiment of the present disclosure, the difference between the third embodiment and the first embodiment lies in that the heating element 112 further includes a bonding layer 1125 arranged between the antioxidant layer 1123 and the infrared radiation layer 1124. The bonding layer 1125 may be configured to prevent the heating substrate 1122 from being broken down locally, thereby further improving the bonding strength between the antioxidant layer 1123 and the infrared radiation layer 1124. In some embodiments, the bond in the bonding layer 1125 may be glass powder, that is, the bonding layer 1125 may be a glass powder layer.

In some embodiments, the bond may also be added to the infrared radiation layer 1124, and the melting point of the glass powder selectable for the bonding layer 1125 is higher than the melting point of the glass powder in the infrared radiation layer 1124.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly, comprising:
a heating portion configured to generate infrared light waves in a power-on state; and
a sleeve for the infrared light waves to pass through,
wherein the heating portion comprises a heating substrate,
wherein an antioxidant layer is arranged on an outer surface of the heating substrate and configured to prevent the heating substrate from being oxidized,
wherein an infrared radiation layer is arranged on a side of the antioxidant layer away from the heating substrate,
wherein an accommodating cavity configured to accommodate the heating portion and is formed in the sleeve, the accommodating cavity being non-sealed, and
wherein the heating portion is at least partially spaced apart from a tube wall of the sleeve.

2. The heating assembly of claim 1, wherein the antioxidant layer comprises an oxide film, and wherein the oxide film is formed on an outer surface of the heating substrate.

3. The heating assembly of claim 1, wherein a thickness of the antioxidant layer is 1 um-150 um.

4. The heating assembly of claim 1, wherein the sleeve comprises a hollow tubular body,
wherein the accommodating cavity is formed in the tubular body, and
wherein one end of the tubular body is provided with an opening.

5. The heating assembly of claim 4, wherein the heating portion is connected to two conductive portions, and
wherein the two conductive portions penetrate through the opening.

6. The heating assembly of claim 4, wherein the sleeve comprises a pointed structure, and
wherein the pointed structure is arranged at an end of the tubular body away from the opening.

7. The heating assembly of claim 5, further comprising:
an insulating member at least partially arranged in the sleeve and configured to insulate the two conductive portions.

8. The heating assembly of claim 5, further comprising:
a supporting base configured to support the heating portion and the sleeve, the sleeve being at least partially inserted into the supporting base; and
a conductive member connected to the conductive portions in the supporting base.

9. The heating assembly of claim 8, wherein the supporting base comprises a holder configured to support the sleeve, and a seal member, and
wherein the seal member is sleeved over a partial section of the sleeve and seals a gap between an inner wall of the holder and an outer wall of the sleeve.

10. The heating assembly of claim 9, wherein the seal member is a hollow structure with two ends running through, and
wherein a channel for the sleeve to pass through is formed on an inner side of the hollow structure.

11. The heating assembly of claim 10, wherein the seal member comprises a sleeve body with two ends running through, the seal member being configured to be partially sleeved over the sleeve,
wherein a first seal portion protrudes from an outer side wall of the sleeve body, and
wherein the first seal portion is clamped and fixed with the holder.

12. The heating assembly of claim 11, wherein the supporting base comprises a shell sleeved over an outer periphery of the holder and is provided with a sleeve opening configured to cooperate with the holder, and
wherein the holder comprises a bottom wall, and a gap is provided between the sleeve opening and the bottom wall.

13. The heating assembly of claim 12, wherein the shell is detachably sleeved over the holder, and
wherein the shell is provided with a through hole for the heating structure to partially penetrate through.

14. The heating assembly of claim 13, wherein the seal member comprises a sleeve body with two ends running through, the seal member being configured to be partially sleeved over the sleeve, and a second seal portion protruding from an outer side wall of the sleeve body, and
wherein the second seal portion is located between the holder and the shell in an assembled state of the shell and the holder, and is configured to seal a gap formed between the holder and an end surface of the through hole.

15. The heating assembly of claim 1, wherein the sleeve comprises infrared transparent glass, transparent ceramics, or diamond.

16. The heating assembly of claim 1, wherein the heating element is spaced apart from the tube wall of the sleeve on the whole.

17. The heating assembly of claim 1, wherein the heating element is arranged without being in direct contact with the sleeve.

18. The heating assembly of claim 1, wherein the infrared radiation layer comprises an infrared layer and/or a composite infrared layer, and
wherein the composite infrared layer is formed by compounding an infrared layer forming substrate with a bond configured to bond with the antioxidant layer.

19. The heating assembly of claim 1, wherein the heating substrate comprises a metal substrate, and
wherein the metal substrate comprises a nickel-chromium alloy substrate or an iron-chromium-aluminum alloy substrate.

20. An aerosol generating device, comprising:
the heating assembly of claim 1.
